(19) United States
(12) Patent Application Publication
(10) Pub. No.: US 2016/0004347 A1
(43) Pub. Date: Jan. 7, 2016

(54) TOUCH SENSING APPARATUS AND TOUCH SENSING METHOD

(71) Applicant: Elan Microelectronics Corporation, HsinChu (TW)

(72) Inventors: Chia-Hsing Lin, Hsinchu City (TW); Han-Wei Chen, Taipei City (TW); Jyun-Yu Chen, New Taipei City (TW)

(21) Appl. No.: 14/687,933

(22) Filed: Apr. 16, 2015

(30) Foreign Application Priority Data
Jul. 1, 2014 (TW) 103122727

(51) Int. Cl. G06F 3/044

(52) U.S. Cl. CPC G06F 3/044

(57) ABSTRACT

A touch sensing apparatus includes an excitation source, a capacitor under test, a sampling circuit and a filter. The excitation source is used to generate an excitation signal having a first frequency. The capacitor under test is used to receive the excitation signal, and generate a sensing signal. The sampling circuit is used to sample the sensing signal to generate a digital output. The sampling circuit includes a pulse density modulation unit operating at a second frequency to generate the digital output, wherein the second frequency is higher than the first frequency. The filter is coupled to the pulse density modulation unit, and arranged to filter the digital output.

### BACKGROUND OF THE INVENTION

1. Field of the Invention

The present invention relates to a touch sensing apparatus, and more particularly, to a touch sensing apparatus and an associated method arranged for detecting capacitance.

2. Description of the Prior Art

Capacitive sensing is a common technique applied in electronic products. Capacitive sensing can be applied to various sensors to detect the distance, location, and displacement of a device under test. Capacitive touch pad, or touch panel, employs a capacitive sensing technique, which can be combined with multi-points touch sensing and gestures of a user to facilitate a wide range of applications such as controlling the mouse cursor, scaling pictures, and scrolling windows of a personal computer. Currently, most smart phones and tablets use capacitive touch panels as input tools.

There are two types of capacitive sensing technique: self-capacitive sensing and mutual capacitive sensing. These two capacitive sensing techniques may raise the correctness of touch sensing by using a narrow-band low-pass filter (LPF) to reduce noise. In current designs, the employed sampling frequency is identical to the frequency of the excitation signal. The sample numbers is limited by the reporting rate of the scan. A conventional method arranged for increasing the signal-to-noise ratio (SNR) is to raise the driving voltage. This results in more power consumption, however.

Therefore, there is a need for a novel method and apparatus that can solve noise issue of the touch sensing apparatus without raising the driving voltage.

### SUMMARY OF THE INVENTION

An embodiment of the present invention provides a touch sensing apparatus, which includes an excitation source, a capacitor under test, a sampling circuit and a filter. The excitation source is arranged to provide an excitation signal having a first frequency. The capacitor under test is coupled to the excitation source, and is arranged to receive the excitation signal and generate a sensing signal. The sampling circuit is used to sample the sensing signal to generate a digital output, wherein the sampling circuit includes a pulse density modulation unit which has an input end coupled to the capacitor under test. The pulse density modulation unit samples a signal received at the input end with a second frequency to generate the digital output, wherein the second frequency is higher than the first frequency. The filter is coupled to the pulse density modulation unit, and is arranged to filter the digital output to generate a filtered signal.

Another embodiment of the present invention provides a touch sensing method, which comprises: providing an excitation signal having a first frequency to a capacitor under test to generate a sensing signal; performing a sampling step to the sensing signal, the sampling step comprising: performing a pulse density modulation at a second frequency to generate a digital output, wherein the second frequency is higher than the first frequency; and filtering the digital output, to generate a filtered signal.

The signal-to-noise ratio (SNR) of the touch sensing apparatus may be raised by utilizing the embodiments of the present invention.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a touch sensing apparatus according to an embodiment of the present invention.

FIG. 2 is a diagram illustrating a touch sensing apparatus according to another embodiment of the present invention.

FIG. 3 is a diagram illustrating a touch sensing apparatus according to another embodiment of the present invention.

FIG. 4 is a diagram illustrating a pulse density modulation unit of the touch sensing apparatus shown in FIG. 1/FIG. 2 according to an embodiment of the present invention.

FIG. 5 is a spectrum diagram of the touch sensing apparatus shown in FIG. 3.

FIG. 6 is diagram illustrating an equivalent circuit of the pulse density modulation unit of the touch sensing apparatus shown in FIG. 1/FIG. 2.

FIG. 7 is a diagram illustrating a touch sensing apparatus according to another embodiment of the present invention.

FIG. 8 is a diagram illustrating a touch sensing apparatus according to another embodiment of the present invention.

FIG. 9 is a spectrum diagram of the touch sensing apparatus shown in FIG. 8.

FIG. 10 is a diagram illustrating a touch sensing apparatus according to another embodiment of the present invention.

FIG. 11 is a spectrum diagram of the touch sensing apparatus shown in FIG. 10.

FIG. 12 is a waveform diagram of phase control signals received by the full wave rectifying circuit shown in FIG. 10.

FIGS. 13-15 are diagrams illustrating embodiments of the low-pass filter shown in FIG. 3.

FIG. 16 is a flowchart illustrating a sampling method of the present invention.

FIG. 17 is a diagram illustrating a touch sensing apparatus of the present invention.

### DETAILED DESCRIPTION

Certain terms are used throughout the description and following claims to refer to particular components. As one skilled in the art will appreciate, manufacturers may refer to a component by different names. This document does not intend to distinguish between components that differ in name but not function. In the following description and in the claims, the terms “include” and “comprise” are used in an open-ended fashion, and thus should not be interpreted as a close-ended term such as “consist of”. Also, the term “couple” is intended to mean either an indirect or direct electrical connection. Accordingly, if one device is coupled to another device, that connection may be through a direct electrical connection, or through an indirect electrical connection via other devices and connections.

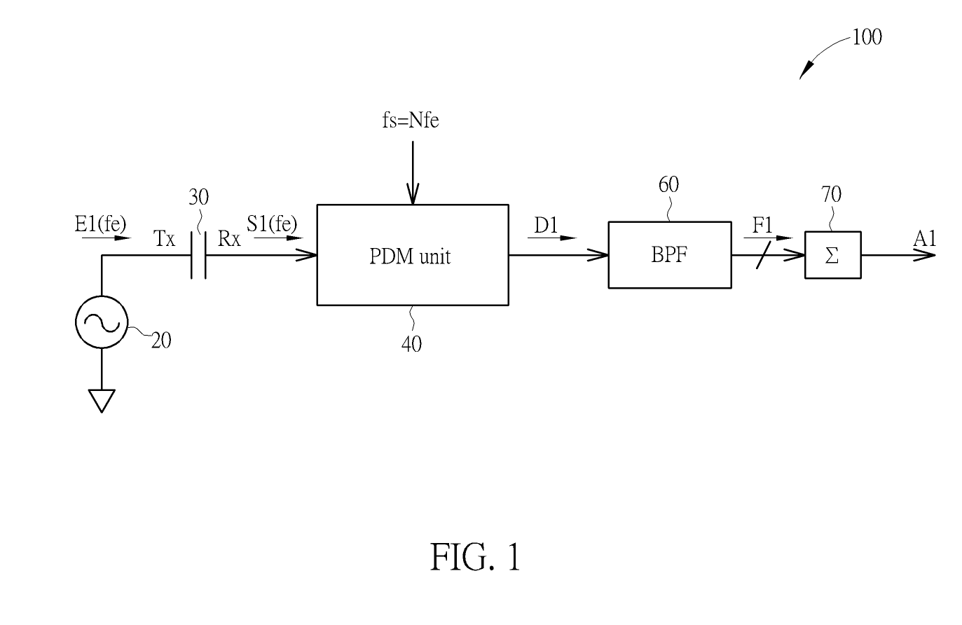

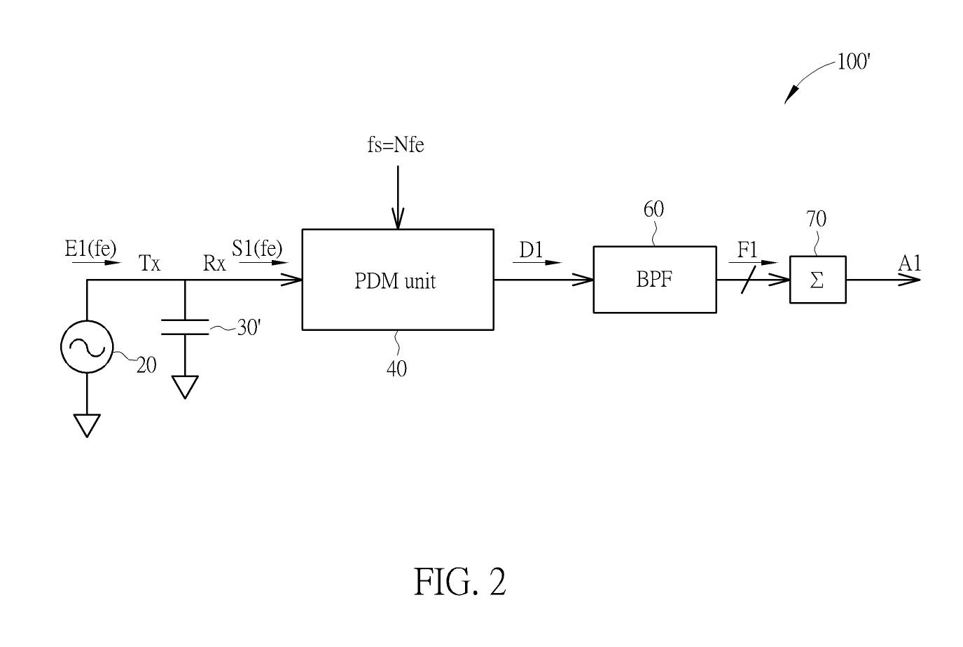

Refer to FIG. 1 and FIG. 2, which show two respective embodiments of the touch sensing apparatus 100 of the present invention. As shown in FIG. 1, the touch sensing apparatus 100 includes an excitation source 20, a capacitor under test 30, a pulse density modulation (PDM) unit 40, a band-pass filter (BPF) 60 and an accumulator 70 (denoted as Σ). The excitation source 20 is used to provide an excitation signal E1 having a first frequency fe to the capacitor under test 30. The capacitor under test 30 is coupled to the excitation source 20 for receiving the excitation signal E1 and generating a sensing signal S1 of the first frequency fe. The scheme of the touch sensing apparatus 100′ shown in FIG. 2 is similar to that of the touch sensing apparatus 100 shown in FIG. 1. The main difference between the touch sensing apparatus 100 and 100′ is that the capacitor under test 30 shown in FIG. 1 is mutual-capacitance between two sensors (e.g. sensing traces), while the capacitor under test 30′ shown in FIG. 2 is self-capacitance between a sensor (e.g. a sensing trace) and the ground. According to the touch sensing apparatus 100/100′ of the present invention, the self-capacitance/mutual-capacitance of the sensors of the capacitive touch panel can be measured. The aforementioned two capacitors under test may generate capacitance variation in response to the approach or touch of a conductor (e.g. a finger of a user), and the capacitance variation can be used for detection of the approach or touch of the conductor. In FIG. 1 and FIG. 2, the symbol Tx represents the excitation end of the capacitor under test, and the symbol Rx represents the receiving end of the capacitor under test 30. In FIG. 2, the capacitor under test 30′ represents the capacitor between a conductor and ground, and the excitation Tx end thereof is exactly the receiving end Rx thereof.

The pulse density modulation unit 40 is coupled to the capacitor under test 30, and arranged to receive the sensing signal S1 from the capacitor under test 30. The pulse density modulation unit 40 performs a pulse density modulation at a second frequency fs on the sensing signal S1 to generate a digital output D1, wherein the second frequency fs is higher than the first frequency fe, the second frequency fs may be N times the first frequency fe, and N is a positive number larger than 1 (e.g. 2). The band-pass filter 60 is coupled to the pulse density modulation unit 40, and arranged to filter the digital output D1, to generate a filtered signal F1. The accumulator 70 is coupled to the band-pass filter 60, and arranged to accumulate the filtered signal F1 to generate an accumulated signal A1. This accumulated signal A1 is a low noise signal outputted to the following processing circuits (not shown).

The pulse density modulation unit 40 samples with the second frequency fs (e.g. N*fe) which is higher than the first frequency fe may obtain more samples. In an embodiment, the pulse density modulation unit 40 may use fewer bits to represent the sampling result. For example, the pulse density modulation unit 40 samples the sensing signal S1 with a frequency which is 64 times the first frequency (64*fe), and represents the sampling result in 1-bit manner to generate the digital output D1. The sampling numbers obtained in this situation will be 64 times the sampling numbers obtained by using the sampling frequency fe. Due to the increase in sampling numbers, the sampled signals do not need to be represented in multiple bits, and still can be processed by the following processing circuits to obtain the correct sensing result. Certainly, the pulse density modulation unit 40 may also use more bits to represent the sampling result, but the complexity and cost of the circuits will be increased accordingly. Using fewer bits to represent the sampling result is helpful to simplify the following filters design. The aforementioned schemes and methods of the present invention are simple to be implemented, and the effect of suppressing noise is notable. More particularly, the signal-to-noise ratio (SNR) is increased without raising the voltage of the excitation signal.

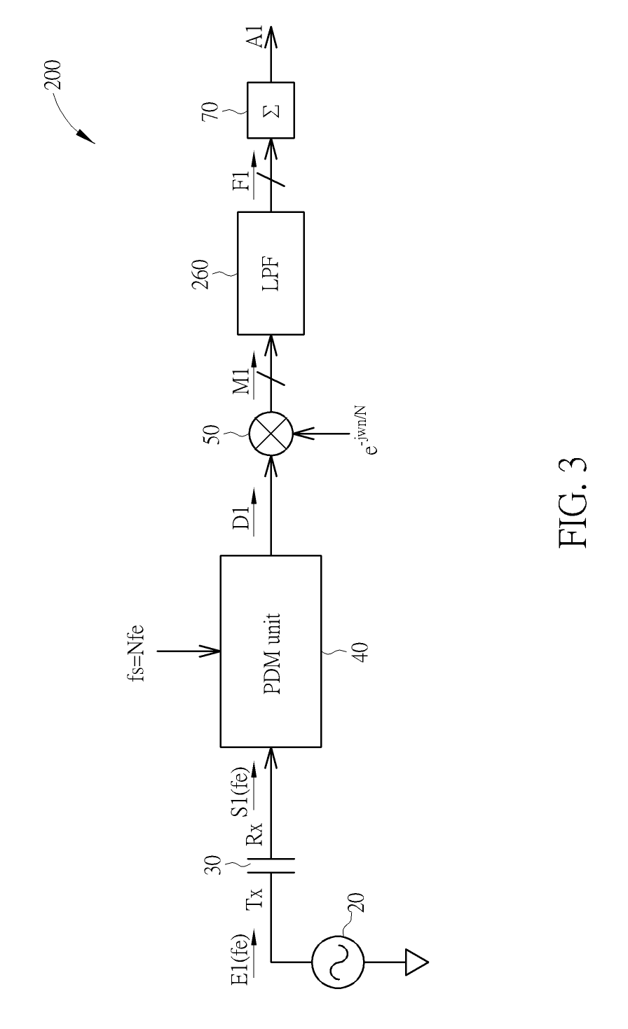

Please refer to FIG. 3, which is a diagram illustrating a touch sensing apparatus 200 according to another embodiment of the present invention. The difference between the touch sensing apparatus 200 and the touch sensing apparatus 100 is that the touch sensing apparatus 200 comprises a mixer 50 and a low-pass filter (LPF) 260. The mixer 50 is coupled between the pulse density modulation unit 40 and the low-pass filter 260, and arranged to shift the spectrum of the digital output D1. In the embodiment of FIG. 3, the mixer 50 is used to shift the spectrum of the digital output D1 to a low frequency to generate the digital output M1, and then output the digital output M1 to the low-pass filter 260. In this embodiment, the mixer 50 is implemented with a multiplier, but the present invention is not limited thereto. The mixer 50 multiplies e^{-jωn/N} to the digital output D1, to obtain the digital output M1 of a low frequency, wherein n is a variable that varies with each sampling time, i.e. n=0, 1, . . . , N−1. The value of n is changed according to the sampling order. For example, when sampling for the first time, n=0; and when sampling for the second time, n=1. Until the Nth sampling time is completed, n=N−1. Next, another N sampling times will be performed, wherein ω=2*π*fs, and fs is the sampling frequency employed by the pulse density modulation unit 40.

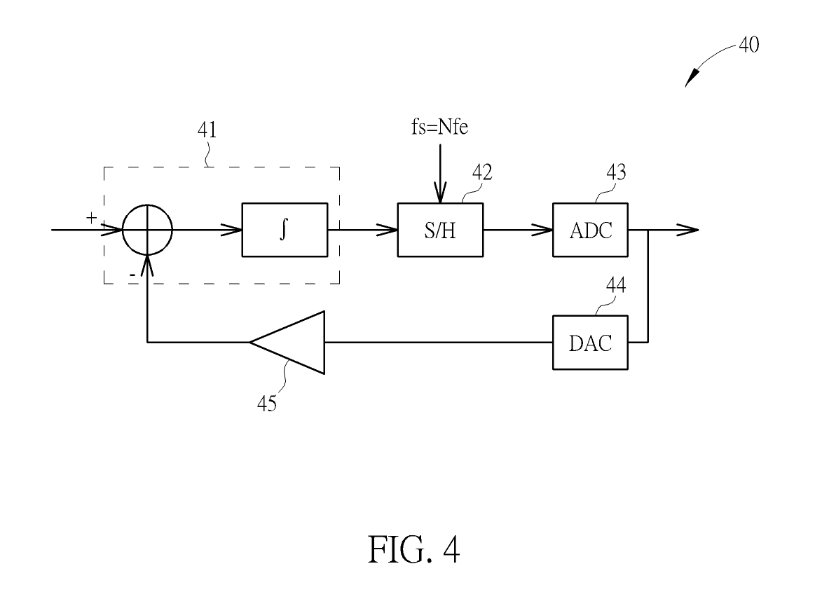

Refer to FIG. 4, which is a diagram illustrating a pulse density modulation unit 40 as shown in FIG. 1/FIG. 2 according to an embodiment of the present invention. In this embodiment, the pulse density modulation unit 40 is implemented with a sigma-delta (ΔΣ) analog-to-digital convertor (ADC). The sigma-delta ADC is used to perform noise-shaping to quantization noise. In general, the quantization noise is uniformly distributed in various frequencies. After the processing of the sigma-delta ADC, a processed signal having less quantized noise may be obtained. When the number of modulation orders of the delta-sigma ADC is increased (e.g. configuring more orders of integrators), the noise-shaping effect will be more obvious. In this embodiment, the pulse density modulation unit 40 comprises a summing integrator 41, a sample-and-hold (S/H) unit 42, an analog-to-digital converter (ADC) 43, a digital-to-analog convertor (DAC) 44 and a gain control unit 45. The S/H unit 42 employs the second frequency fs as the sampling frequency, wherein the second frequency fs is N times the excitation signal fe. Since the sigma-delta ADC is a common circuit, the detailed descriptions thereof are omitted here for brevity.

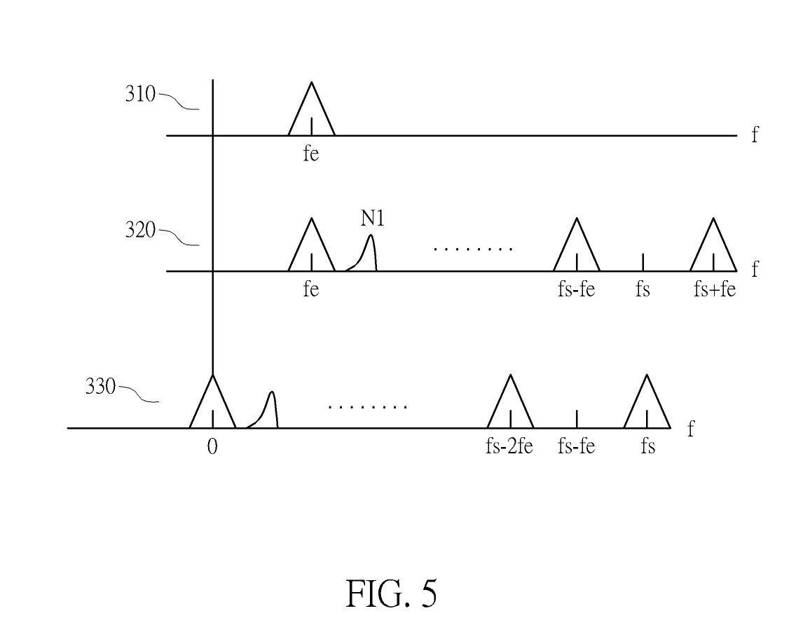

Please refer to FIG. 5, which is a spectrum diagram corresponding to the touch sensing apparatus 200 shown in FIG. 3. Numeral 310 shows the spectrum of the excitation signal E1 of the first frequency fe. Numeral 320 shows the spectrum of the digital output D1 obtained by using the density modulation unit 40 to perform over sampling with the second frequency fs. Numeral 330 shows the spectrum of the digital output M1 outputted from the mixer 50. The spectrum 320 comprises a signal of first frequency fe and signals of frequency K*(fs−fe) and K*(fs+fe) located at both sides of the second frequency (i.e. the sampling frequency) fs, wherein K is an integer. The quantized noise N1 appears at the right side of the first frequency fe. By utilizing the mixer 50 shown in FIG. 3 to shift the spectrum 320 as the spectrum 330, the signal of the first frequency fe and the quantized noise N1 are both left shifted, wherein the signal of the first frequency fe in spectrum 320 is shifted to the zero point of the spectrum 330, and the quantized noise N1 is also shifted to a lower frequency location. The touch sensing apparatus 200 may use a narrow-band low-pass filter 260 to filter the quantized noise N1 to obtain the signal at the zero point of the spectrum. Note that the aforementioned zero point of the spectrum refers to the location at zero frequency on the spectrum, and the signal located at the zero point is a direct current (DC) signal.

The touch sensing apparatus 100/100′ shown in FIG. 1/FIG. 2 does not comprise a mixer. Instead, the schemes shown in FIG. 1/FIG. 2 adopt the band-pass filter 60 to directly filter the quantized noise N1 in the spectrum 320. Although this design omits the mixer, the cost of a band-pass filter is higher than that of a low-pass filter. User may select the schemes illustrated in FIGS. 1-3 based on actual design requirements.

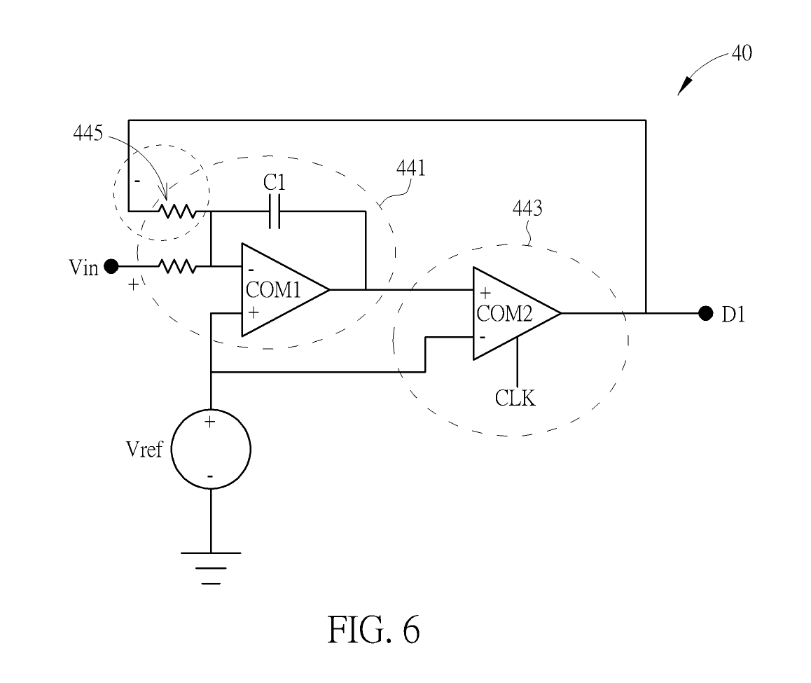

FIG. 6 shows an equivalent circuit obtained by configuring the gain of the gain control unit 45 to be 1 and configuring a 1-bit DAC 44 in FIG. 4. FIG. 6 may be considered an equivalent circuit diagram of an embodiment of the pulse density modulation unit 40 shown in FIG. 4. In FIG. 6, the pulse density modulation unit 40 is a 1-bit sigma-delta ADC, which comprises a summing integration unit 441 and a 1-bit ADC 443. The summing integration unit 441 includes a comparator COM1, a capacitor C1 and a gain control resistor 445, wherein the negative input end (denoted as “−”) of the comparator COM1 is coupled to the input voltage Vin (e.g. the sensing signal from the capacitor under test 30), and the positive input end (denoted as “+”) of the comparator COM1 is coupled to a reference voltage Vref. The 1-bit ADC 443 is controlled by a clock signal CLK, and includes a comparator COM2, wherein the negative end (−) of the comparator COM2 is coupled to the reference voltage Vref and the positive input end of the comparator COM1, and the positive input end (+) of the comparator COM2 is coupled to the output end of the comparator COM1. The comparator COM2 outputs the digital output D1, and the digital output D1 is sent to the negative input end of the comparator COM1 through the gain control resistor 445, to be added to the input voltage Vin. In this embodiment, the summing integration unit 441 is equivalent to the summing integrator 41 shown in FIG. 4, the comparator COM2 is equivalent to the S/H unit 42 and the ADC 43 shown in FIG. 4, and the gain control resistor 445 is equivalent to the adder of the summing integrator 41 shown in FIG. 4.

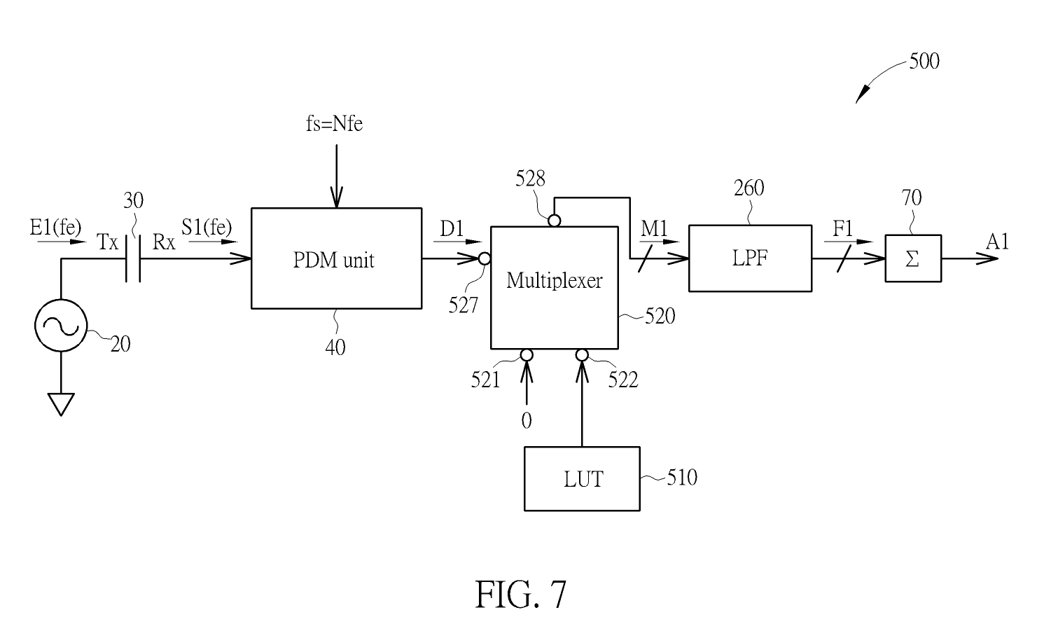

Please refer to FIG. 7, which is a diagram illustrating a touch sensing apparatus 500 according to another embodiment of the present invention. In FIG. 7, the pulse density modulation unit 40 adopts a 1-bit sigma-delta ADC, and the mixer 50 adopts a 1-bit multiplier. The 1-bit multiplier comprises a look-up table (LUT) 510 and a multiplexer 520. The look-up table 510 is arranged to provide a look-up output. For example, the look-up output may be the aforementioned e^{-jωn/N}, and the value of e^{-jωn/N} may be determined in the look-up table 510 according to the index n. The multiplexer 520 has a first input end 521, a second input end 522, a control end 527 and an output end 528, wherein the first input end 521 is arranged to receive a predetermined value (e.g. 0), the second input end 522 is arranged to receive the output of the look-up table 510, the control end 527 is arranged to receive the digital output D1, and the multiplexer 520 is arranged to output the predetermined value or the look-up output of the look-up table 510 at the output end 528 according to the bit value of the digital output D1. For example, if the bit value of the digital output D1 is 0, the multiplexer 520 outputs the predetermined value (e.g. 0) at the output end 528; and when the bit value of the digital output D1 is 1, the multiplexer 520 outputs the look-up output of the look-up table 510 at the output end 528.

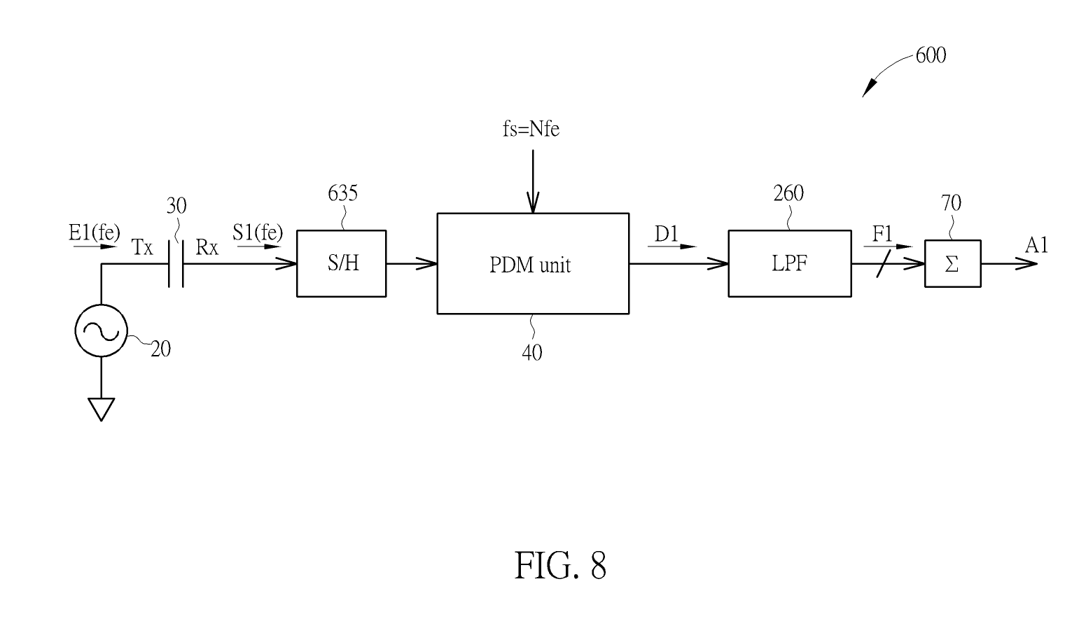

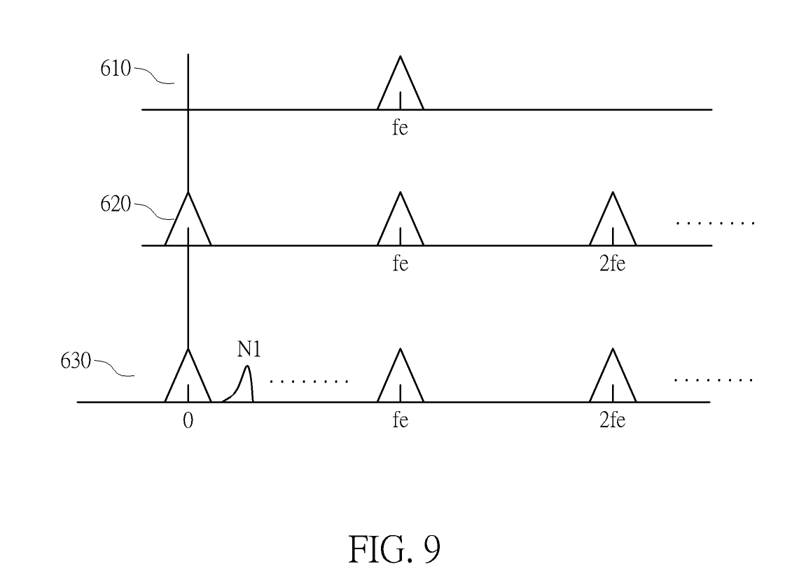

Please refer to FIG. 8 and FIG. 9. FIG. 8 is a diagram illustrating a touch sensing apparatus 600 according to another embodiment of the present invention, and FIG. 9 is a spectrum diagram corresponding to the touch sensing apparatus 600 shown in FIG. 8. Compared with the touch sensing apparatus 200 shown in FIG. 3, the touch sensing apparatus 600 does not comprise a mixer, but further comprises a pre-sample-and-hold (S/H) circuit 635. The pre-sample-and-hold circuit 635 is coupled to the input end of the pulse density modulation unit 40, and arranged to sample-and-hold the sensing signal S1, wherein the pre-sample-and-hold circuit 635 employs the first frequency fe as the sampling frequency. The signal processed by the pre-sample-and-hold circuit 635 is then modulated by the pulse density modulation unit 40. In FIG. 9, numeral 610 shows the spectrum of the sensing signal S1 of the first frequency fe, numeral 620 shows the spectrum of the signal processed by the pre-sample-and-hold circuit 635, and numeral 630 shows the spectrum of the signal oversampled by the pulse density modulation unit 40. In the spectrum 620, there is a signal at the zero point. In the spectrum 630, quantized noise N1 is generated at the right side of the zero point. The touch sensing apparatus 600 may use the narrow-band low-pass filter 260 to filter the quantized noise N1 to obtain the signal at the zero point of the spectrum 630.

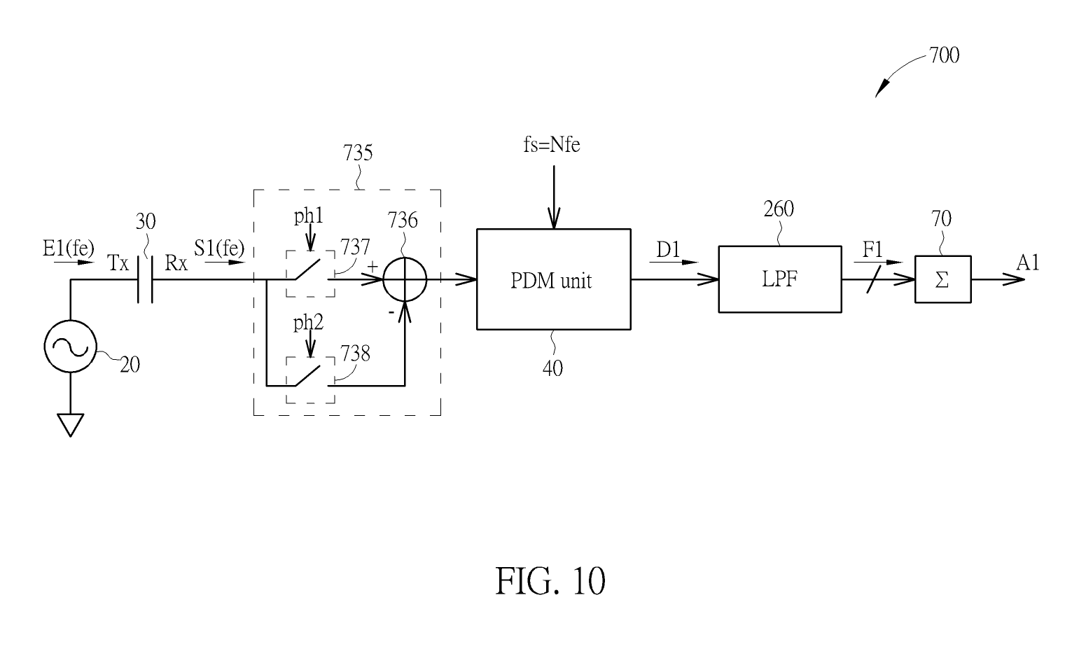

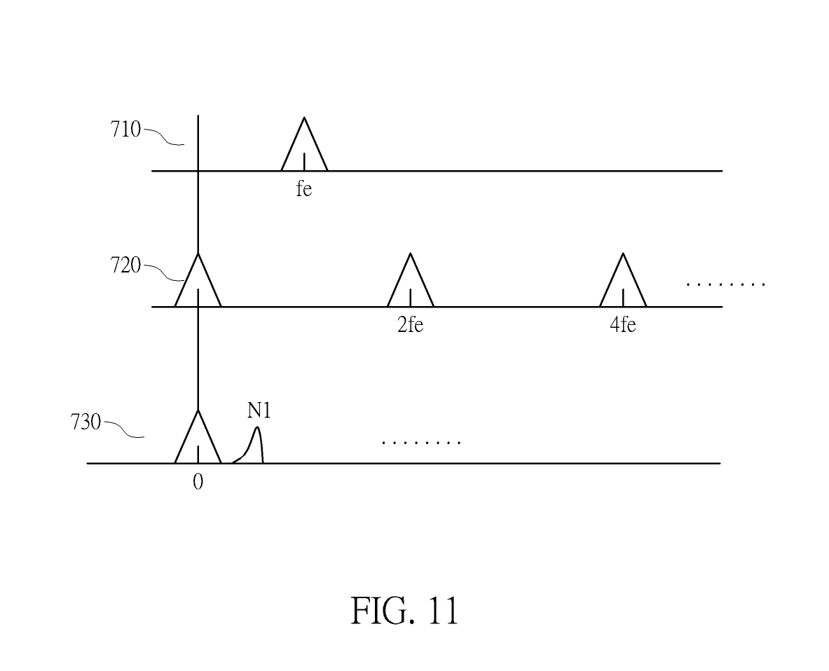

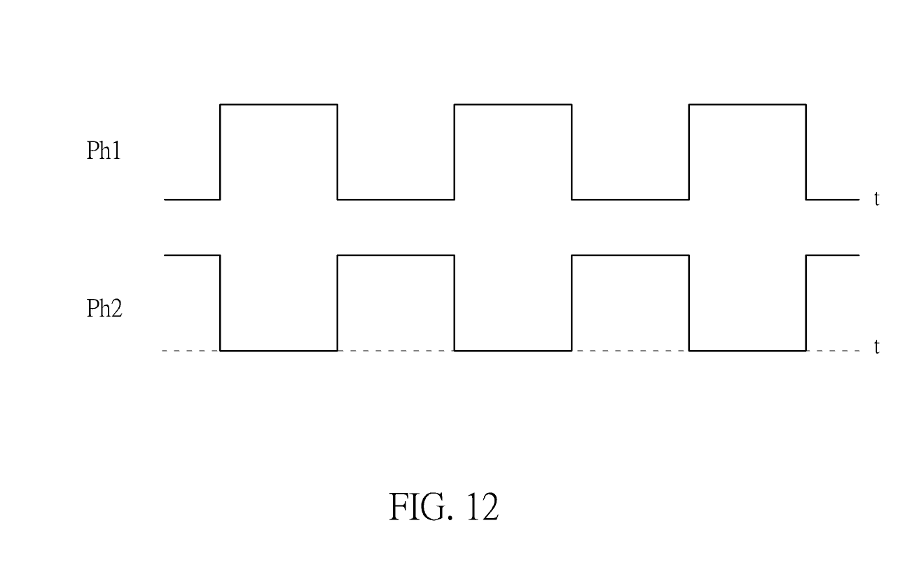

Please refer to FIGS. 10-12. FIG. 10 is a diagram illustrating a touch sensing apparatus 700 according to another embodiment of the present invention. FIG. 11 is a spectrum diagram corresponding to the touch sensing apparatus 700 shown in FIG. 10. FIG. 12 is a waveform diagram of phase control signals received by the full wave rectifying circuit 735 shown in FIG. 10. Compared with the touch sensing apparatus 200 shown in FIG. 3, the touch sensing apparatus 700 does not comprise a mixer, but further comprise the full wave rectifying circuit 735, wherein the full wave rectifying circuit 735 is coupled to the input end of the pulse density modulation unit 40 and arranged to perform full wave rectification on the sensing signal S1 to generate an output signal having a frequency of 2fe. Then, pulse density modulation is performed on the full wave rectified signal by the pulse density modulation unit 40. In this embodiment, the full wave rectifying circuit 735 comprises an adder 736 and two switches 737 and 738, wherein the switch 737 is controlled by the first phase control signal ph1, and another switch 738 is controlled by the second phase control signal ph2. It can be seen from FIG. 12 that, when the switch 737 is turned on, the switch 738 is turned off at the same time. Similarly, when the switch 738 is turned on, the switch 737 is turned off at the same time. The adder 736 is arranged to subtract the output of the switch 738 from the output of the switch 737 to generate the full wave rectified signal, wherein the frequency of the full wave rectified signal is twice the frequency fe of the sensing signal S1. In FIG. 11, numeral 710 shows the spectrum of the sensing signal S1, numeral 720 shows the spectrum of the signal processed by the full wave rectifying circuit 735, and numeral 730 shows the spectrum of the signal oversampled by the pulse density modulation unit 40. In spectrum 720, there is a signal located at the zero point. In the spectrum 730, after the oversampling of the pulse density modulation unit 40 with N times frequency, the quantized noise N1 is generated at the right side of the zero point. Hence, the touch sensing apparatus 700 may use the narrow-band low-pass filter 260 to filter the quantized noise N1 to obtain the signal at the zero point of the spectrum 730.

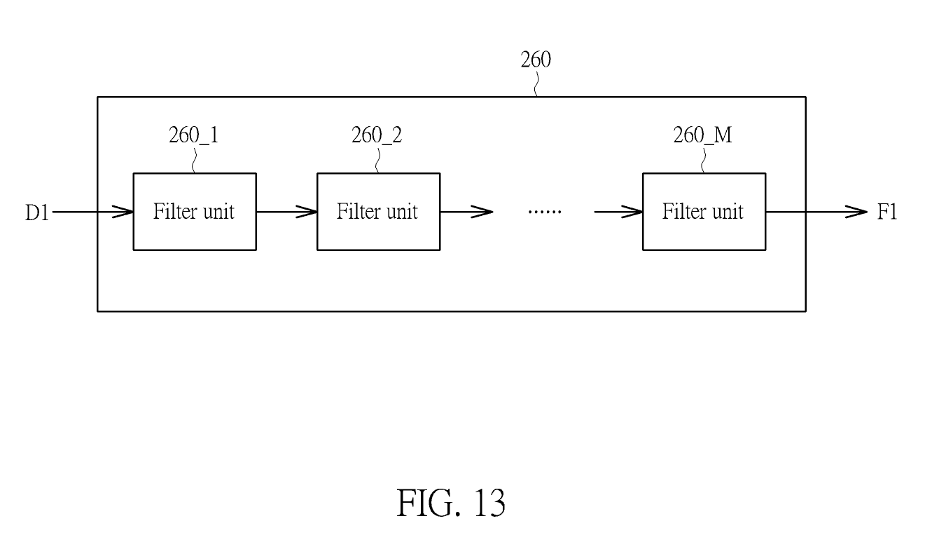

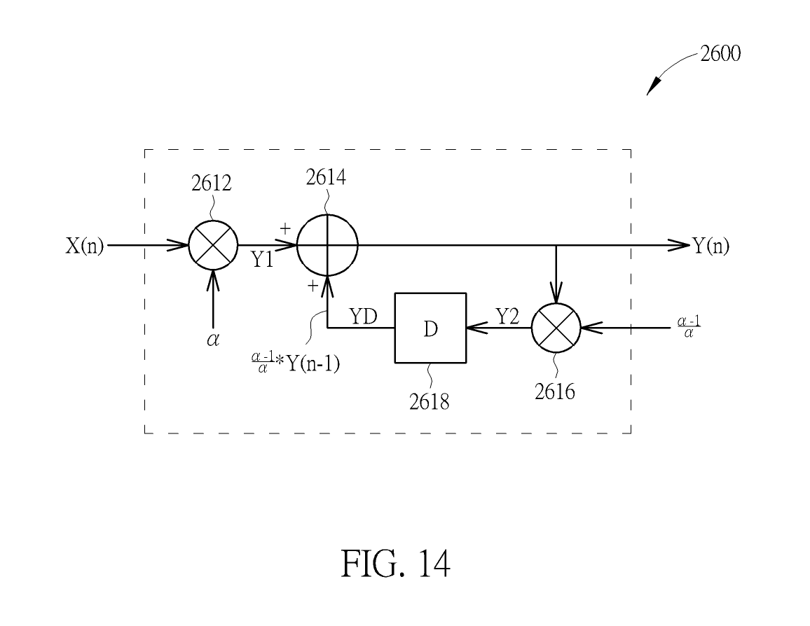

Please refer to FIGS. 13-15, which are diagrams illustrating embodiments of the low-pass filter 260 shown in FIG. 3. As shown in FIG. 13, the low-pass filter 260 may comprise M stages of filter units 260_1-260_M, wherein M can be determined according to design requirements. Employing more stages of filter unit may achieve a better filtering effect, but the hardware cost will be raised accordingly. Each stage of filter unit comprises a multiplier, an adder and a delayer. As shown in FIG. 14, the filter unit 2600 may be used to implement any one of the filter units 260_1-260_M, and comprises a first multiplier 2612, an adder 2614, a second multiplier 2616 and a delayer 2618. The first multiplier 2612 is arranged to multiply a first parameter α by the digital data X(n), to generate a first output Y1. The digital data X(n) may be output data of a previous stage filter unit (if the filter unit 2600 is not the first filter unit 260_1), or be the digital output D1 of the pulse density modulation unit 40 (if the filter unit 2600 is the first filter unit 260_1). The adder 2614 is coupled to the first multiplier 2612, and arranged to add a delayed output YD and the first output Y1 to generate a filtered output Y(n) to a next stage filter unit (if the filter unit 2600 is not the last stage filter unit 260_M). If the filter unit 2600 is the last stage filter unit 260_M, the filtered output Y(n) is used as the output of the low-pass filter 260 ( ). The second multiplier 2616 is coupled to adder 2614, and arranged to multiply a second parameter ((α−1)/α) by the filtered output Y(n), to generate a second output Y2. The delayer 2618 is coupled between the second multiplier 2616 and the adder 2614, and arranged to delay the second output Y2 to generate the delayed output YD. Since the data is delayed by the delayer 2618, the filtered output Y(n) of the adder 2614 is expressed as the following Formula (1), wherein Y(n−1) is the filtered output of the adder 2614 at a prior moment.

$$Y ( n ) = α X ( n ) + ( \frac{α - 1}{α} ) Y ( n - 1 ) \qquad ( 1 )$$

A better filtering effect can be achieved by applying a larger α, but the hardware cost will be raised accordingly. The value of the parameter α in the low-pass filter 260 and the number of stages (i.e. the value of M) of the filter unit 2600 may be determined according to actual design requirements.

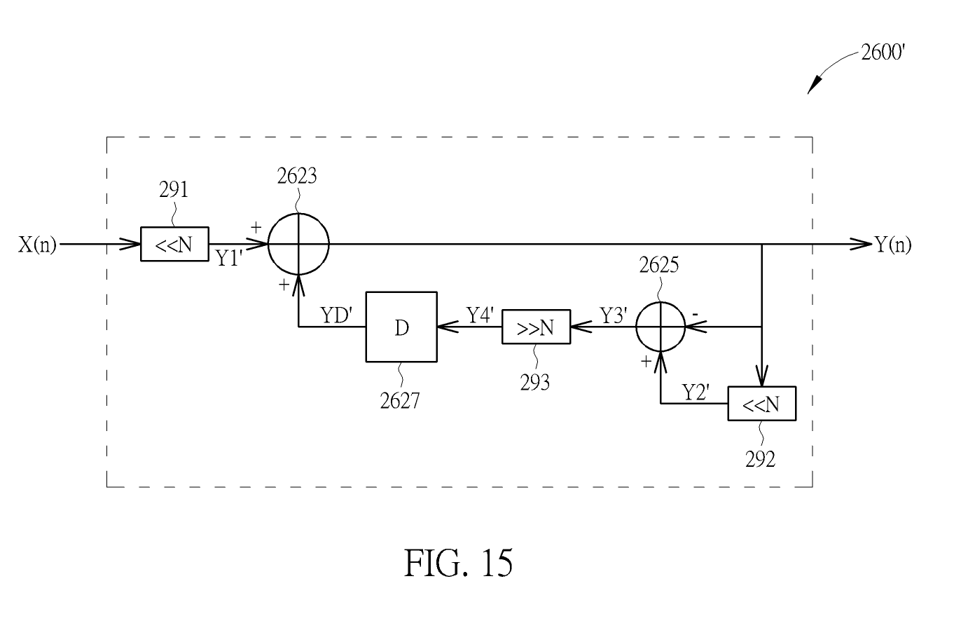

In FIG. 14, the multiplier (or a divider) can be omitted by arranging the value of the parameter α to be a power of 2 (i.e. 2^{N}), because multiplying 2^{N} by a digital number is equivalent to left shifting the digital number by N bits, and dividing a digital number by 2^{N} is equivalent to right shifting the digital number by N bits. The scheme of the filter unit in FIG. 14 can be simplified as the scheme shown in FIG. 15. The filter unit 2600′ may be used to implement any one of the filter units 260_1-260_M. The filter unit 2600′ comprises a first shifter 291, a first adder 2623, a second shifter 292, a second adder 2625, a third shifter 293 and a delayer 2627. The first shifter 291 is used to left shift the digital data X(n), to generate a first output Y1′. The first adder 2623 is coupled to the first shifter 291, and arranged for adding a delayed output YD′ and the first output Y1′ to generate a filtered output Y(n). The second shifter 292 is coupled to the first adder 2625, and arranged for left shifting the filtered output Y(n) to generate the second output Y2′. The symbol “<<N” represents left shifting N bit, and the symbol “>>N” represents right shifting N bit. The second adder 2625 is coupled to the first adder 2623 and the second shifter 292, and arranged to subtract the filtered output Y(n) from the second output Y2′ to generate a third output Y3′. The third shifter 293 is used to right shift the third output Y3′ to generate a fourth output Y4′. The delayer 2627 is coupled between the third shifter 293 and the first adder 2623, and arranged to delay the fourth output Y4′ to generate the delayed output YD′.

In the embodiment of FIG. 15, the multipliers 2612, 2616 shown in FIG. 14 are replaced by the first shifter 291, the second shifter 292, the third shifter 293 and an adder 2625, wherein the first shifter 291 and the third shifter 293 are used to left shift the input data by N bit, and the second shifter 292 is used to right shift the input data by N bit. The filter unit 260_1 shown in FIG. 15 does not need integrators or dividers, which is capable of greatly reducing the complexity and cost of circuits.

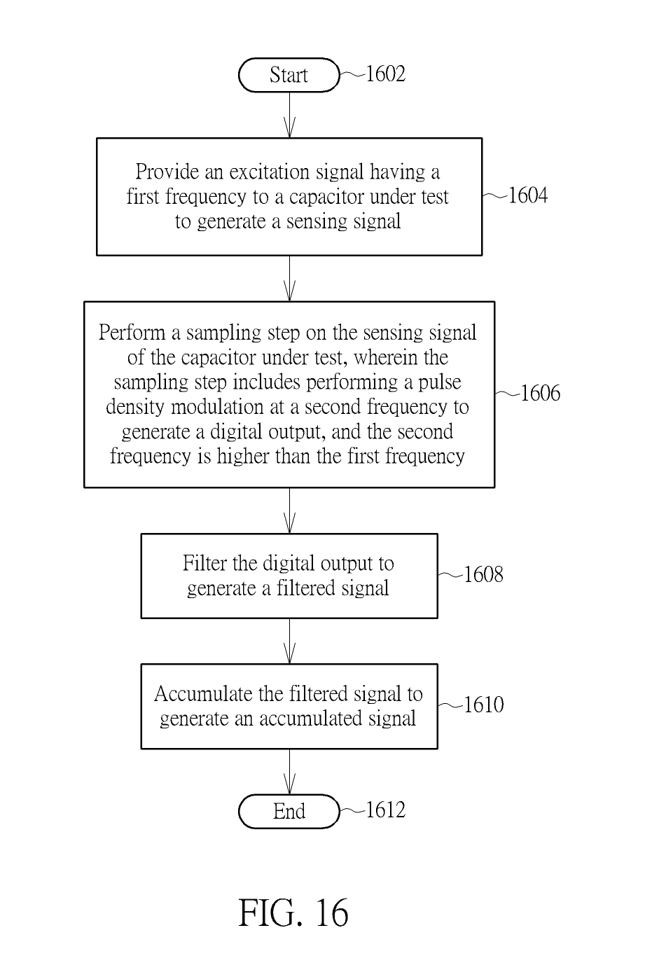

Please refer to FIG. 16, which is a flowchart illustrating a sampling method of the present invention. The sampling method is capable of detecting the approach or touch of conductors. Please note that, if the result is substantially the same, the steps are not required to be executed in the exact order shown in FIG. 16. The method shown in FIG. 16 may be employed by the touch sensing apparatus 100 shown in FIG. 1, and can be briefly summarized as follows.

Step 1602: Start;

Step 1604: Provide an excitation signal having a first frequency to a capacitor under test to generate a sensing signal.

Step 1606: Perform a sampling step on the sensing signal of the capacitor under test, wherein the sampling step includes performing a pulse density modulation at a second frequency to generate a digital output, and the second frequency is higher than the first frequency;

Step 1608: Filter the digital output to generate a filtered signal;

Step 1610: Accumulate the filtered signal to generate an accumulated signal.

Step 1612: End.

As one skilled in the art can understand details of each step in FIG. 16 after reading the above paragraphs directed to the touch sensing apparatus 100, further description is omitted here for brevity.

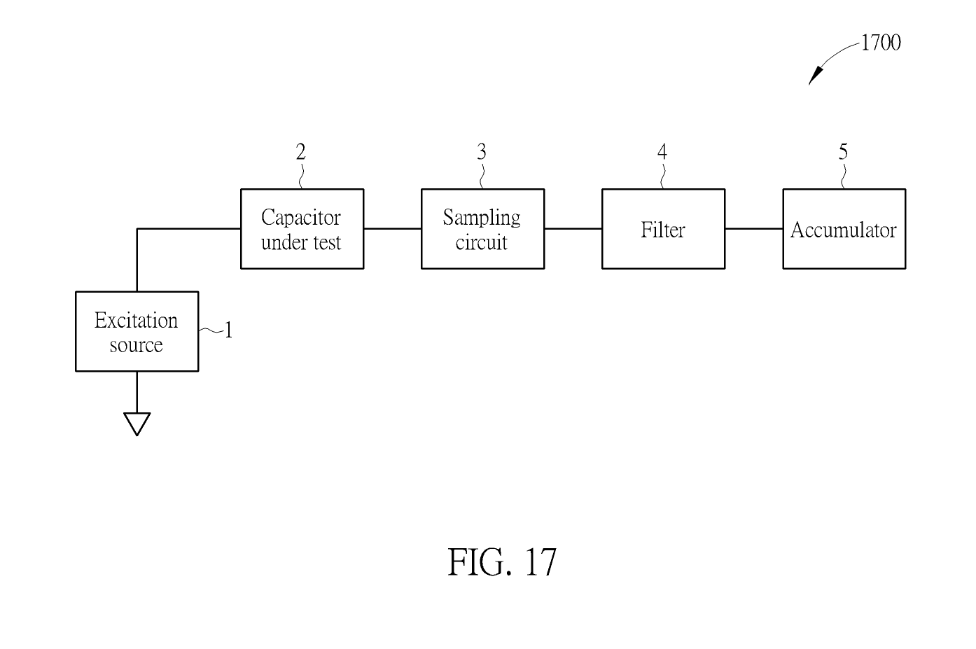

The concept of the present invention can be realized by referring to FIG. 17, which is a diagram illustrating a touch sensing apparatus 1700 of the present invention. The touch sensing apparatus 1700 comprises an excitation source 1, a capacitor under test 2, a sampling circuit 3, a filter 4 and an accumulator 5. The excitation source 1 is arranged to provide an excitation signal having a first frequency. The capacitor under test 2 is coupled to the excitation source 1, and arranged to receive the excitation signal, and generate a sensing signal. The sampling circuit 3 is arranged to sample the sensing signal to generate a digital output, wherein the sampling circuit 3 comprises a pulse density modulation unit (not shown in FIG. 17). The pulse density modulation unit has an input end coupled to the capacitor under test, and samples the signal inputted to the input end with a second frequency to generate the digital output, wherein the second frequency is higher than the first frequency. The filter 4 is coupled to the pulse density modulation unit of the sampling circuit 3, and arranged to filter the digital output to generate a filtered signal.

The sampling circuit 3 may include the pulse density modulation unit 40 only, as shown in FIGS. 1 and 2. The sampling circuit 3 may further include the pre-sample-and-hold circuit 635 coupled to the pulse density modulation unit 40 as shown in FIG. 8, or further include the full wave rectifying circuit 735 coupled to the pulse density modulation unit 40 as shown in FIG. 10. The pulse density modulation unit 40 may be coupled to the capacitor under test 2 directly or through at least one element, and is used to sample the signal inputted to the input end thereof, to generate the digital output.

Based on the examples of the sampling circuit 3 mentioned above, there are many ways to implement the filter 4. For example, the filter 4 may be implemented by the band-pass filter 60 as shown in FIGS. 1 and 2, or implemented by the low-pass filter 260 coupled to the mixer 50 as shown in FIG. 3. The filter 4 may also be implemented by only the low-pass filter 260, as shown in FIGS. 8 and 10.

To summarize, through the embodiments provided by the present invention, the touch sensing apparatus may obtain more sampling signals by using the sampling circuit, thus reducing noise and improving the accuracy of the signal detection. Further, the present invention also provides a simplified scheme of the low-pass filter, so as to further reduce the complexity and cost of circuits.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A touch sensing apparatus comprising:
an excitation source, arranged to generate an excitation signal having a first frequency;
a capacitor under test, arranged to receive the excitation signal, and generate a sensing signal;
a sampling circuit, arranged to sample the sensing signal to generate a digital output, the sampling circuit comprising a pulse density modulation (PDM) unit that has an input end coupled to the capacitor under test,
the pulse density modulation unit sampling a signal received at the input end with a second frequency to generate the digital output, wherein the second frequency is higher than the first frequency; and
a filter, coupled to the pulse density modulation unit, the filter arranged to filter the digital output to generate a filtered signal.

2. The touch sensing apparatus of claim 1, further comprising an accumulator, coupled to the filter, the accumulator arranged to accumulate the filtered signal to generate an accumulated signal.

3. The touch sensing apparatus of claim 1, wherein the pulse density modulation unit is a sigma-delta analog-to-digital convertor (ADC), and a sample-and-hold unit in the sigma-delta ADC employs the second frequency as a sampling frequency.

4. The touch sensing apparatus of claim 3, wherein the sigma-delta ADC comprises a 1-bit ADC, to generate the digital output.

5. The touch sensing apparatus of claim 1, wherein the filter is a band-pass filter.

6. The touch sensing apparatus of claim 1, wherein the filter comprises a mixer and a low-pass filter, the mixer is coupled to the low-pass filter, the mixer receives the digital output, and the low-pass filter filters an output of the mixer.

7. The touch sensing apparatus of claim 6, wherein the mixer is a multiplier.

8. The touch sensing apparatus of claim 1, wherein the sampling circuit comprises a 1-bit ADC arranged for generating the digital output; and the mixer further comprises:
a look-up table, arranged to provide a look-up output; and
a multiplexer, having a first input end, a second input end, a control end and an output end, wherein the first input end receives a predetermined value, the second input end receives the look-up output, the control end receives the digital output, and the multiplexer output the predetermined value or the look-up output on the output end according to the digital output.

9. The touch sensing apparatus of claim 1, wherein the sampling circuit further comprises:
a full wave rectifying circuit, coupled to the pulse density modulation unit, wherein the full wave rectifying circuit is arranged to perform a full wave rectifying operation on the sensing signal, and the pulse density modulation unit samples an output of the full wave rectifying circuit to generate the digital output.

10. The touch sensing apparatus of claim 1, wherein the sampling circuit further comprising:
a pre-sample-and-hold circuit, coupled to the pulse density modulation unit, the pre-sample-and-hold circuit arranged to sample-and-hold the sensing signal, and the pulse density modulation unit arranged to sample an output of the pre-sample-and-hold circuit to generate the digital output, wherein a sampling frequency of the pre-sample-and-hold circuit is equal to the first frequency.

11. The touch sensing apparatus of claim 1, wherein the filter comprises at least a filter unit, and the filter unit comprises:
a first multiplier, arranged to multiply the digital output by a first parameter to generate a first output;
an adder, coupled to the first multiplier, arranged to add a delayed output and the first output to generate a filtered output;
a second multiplier, coupled to the adder, arranged to multiply the filtered output by a second parameter to generate a second output; and
a delayer, coupled between the second multiplier and the adder, the delayer arranged to delay the second output to generate the delayed output.

12. The touch sensing apparatus of claim 1, wherein the filter comprises at least one filter unit, and the filter unit comprises:
a first shifter, arranged to left shift the digital output to generate a first output;
a first adder, coupled to the first shifter, arranged to add a delayed output and the first output to generate a filtered output;
a second shifter, coupled to the first adder, arranged to left shift the filtered output to generate a second output;
a second adder, coupled between the first adder and the second shifter, the second adder arranged to add the second output and a negative value of the filtered output to generate a third output;
a third shifter, arranged to right shift the third output to generate a fourth output; and
a delayer, coupled between the third shifter and the first adder, the delayer arranged to delay the fourth output to generate the delayed output.

13. A touch sensing method, comprising:
providing an excitation signal having a first frequency to a capacitor under test to generate a sensing signal;
performing a sampling step on the sensing signal, the sampling step comprising: performing a pulse density modulation (PDM) at a second frequency to generate a digital output, wherein the second frequency is higher than the first frequency; and filtering the digital output to generate a filtered signal.

14. The method of claim 13, further comprising:
accumulating the filtered signal to generate an accumulated signal.

15. The method of claim 13, wherein the sampling step comprises:
performing the pulse density modulation by a sigma-delta analog-to-digital convertor (ADC) to generate the digital output.

16. The method of claim 13, wherein the step of filtering the digital output to generate a filtered signal comprises:
using a band-pass filter to filter the digital output to generate the filtered signal.

17. The method of claim 13, wherein the step of filtering the digital output to generate a filtered signal comprises:
performing a mixing process upon the digital output to generate a mixed signal, and using a low-pass filter to filter the mixed signal.

18. The method of claim 13, wherein the sampling step further comprises:
performing a full wave rectifying operation upon the sensing signal, and then performing the pulse density modulation on the full wave rectified sensing signal.

19. The method of claim 13, wherein the sampling step further comprises:
sampling and holding the sensing signal, and then performing the pulse density modulation on the sampled and held sensing signal.
